(19) United States
(12) Patent Application Publication
(10) Pub. No.: US 2003/0108024 A1
(43) Pub. Date: Jun. 12, 2003

(54) Orthogonal code generating device and method thereof in a code division multiple access communication system

(75) Inventor: Dong-Hee Kang, Seoul (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., KYUNGKI-DO (KR)

(21) Appl. No.: 10/193,499

(22) Filed: Jul. 11, 2002

(30) Foreign Application Priority Data
Jul. 11, 2001 (KR) P2001-41634

(51) Int. Cl. H04B 7/216

(52) U.S. Cl. 370/342; 370/203

(57) ABSTRACT

An OVSF (Orthogonal Variable Spreading Factor) code generating apparatus and method in a CDMA (Code Division Multiple Access) communication system. A shuffler shuffles an N-bit stream. Here, N is determined by the SF (Spreading code) of an OVSF code and N=log₂SF. A counter outputs an N-bit count value, a first operation device AND-operates the shuffled bits with the N-bit count value bit by bit, and a second operation device XOR-operates the AND-operated bits and outputting the XOR-operated bits as an OVSF code.

This application claims priority to an application entitled “Apparatus and Method for Generating Orthogonal Code in a CDMA Communication System” filed in the Korean Industrial Property Office on Jul. 11, 2001 and assigned Ser. No. 2001-41634, the contents of which are hereby incorporated by reference.

### BACKGROUND OF THE INVENTION

1. Field of the Invention

The present invention relates generally to a CDMA (Code Division Multiple Access) communication system, and in particular, to an apparatus and method for generating OVSF (Orthogonal Variable Spreading Factor) codes as orthogonal codes for channelization.

2. Description of the Related Art

CDMA communication systems including CDMA-2000 and UMTS (Universal Mobile Telecommunication System) adopt orthogonal codes as channelization codes. The 3GPP (3^{rd} Generation Partnership project) uses OVSF codes for channelization at a Node B to remove interference between traffic channels. The OVSF codes are used to ensure orthogonality between input data. To generate the OVSF codes with orthogonality maintained, a code tree is used.

FIG. 1 illustrates a code tree for generating OVSF codes as orthogonal codes in a typical CDMA communication system. Referring to FIG. 1, an odd-numbered OVSF code is generated by inversing data and an even-numbered OVSF code, by repeating the data. The initial data is dumped in a memory. The code tree is further branched through bypassing or inversion according to an intended SF.

A conventional orthogonal code generator must be designed to include elements such as a memory, orthogonal code control logics, and a buffer to generate OVSF codes in the above manner. The use of a memory in the conventional orthogonal code generator takes much time for generation of OVSF codes. Moreover, peripheral circuitry is required to control the memory.

### SUMMARY OF THE INVENTION

It is, therefore, an object of the present invention to provide an apparatus and method for generating orthogonal codes as channelization codes without using a memory in a CDMA communication system.

It is another object of the present invention to provide an apparatus and method for generating orthogonal codes as channelization codes to remove circuit complexity in a CDMA communication system.

It is a further object of the present invention to provide an apparatus and method for generating orthogonal codes as channelization codes in less time in a CDMA communication system.

To achieve the above and other objects, there is provided an OVSF code generating apparatus and method in a CDMA communication system. A shuffler shuffles an N-bit stream. Here, N is determined by the SF of an OVSF code and N=log₂SF. A counter outputs an N-bit count value, a first operation device AND-operates the shuffled bits with the N-bit count value bit by bit, and a second operation device XOR-operates the AND-operated bits and outputting the XOR-operated bits as an OVSF code.

Preferably, the shuffler is an inverter for inverting the N-bit stream on a bit basis.

Preferably, the counter is a binary up counter for outputting an N-bit count value that increases according to a PN (Pseudorandom Noise) code clock signal.

Preferably, the OVSF code is used for a DPCCH or DPDCH.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates an OVSF code tree for channelization in a typical CDMA communication system;

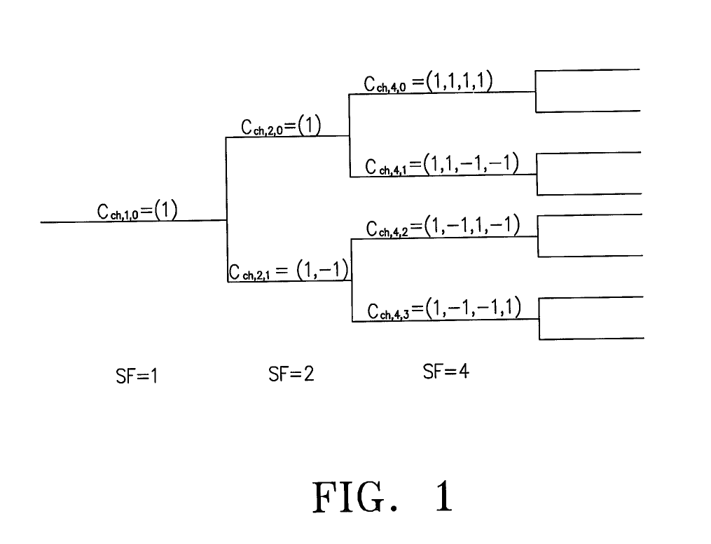

FIG. 2 is a block diagram of an orthogonal code generating apparatus according to an embodiment of the present invention;

FIG. 3 is a block diagram of an implementation of the orthogonal code generating apparatus according to the embodiment of the present invention; and

FIG. 4 is a flowchart illustrating orthogonal code generation according to the embodiment of the present invention.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

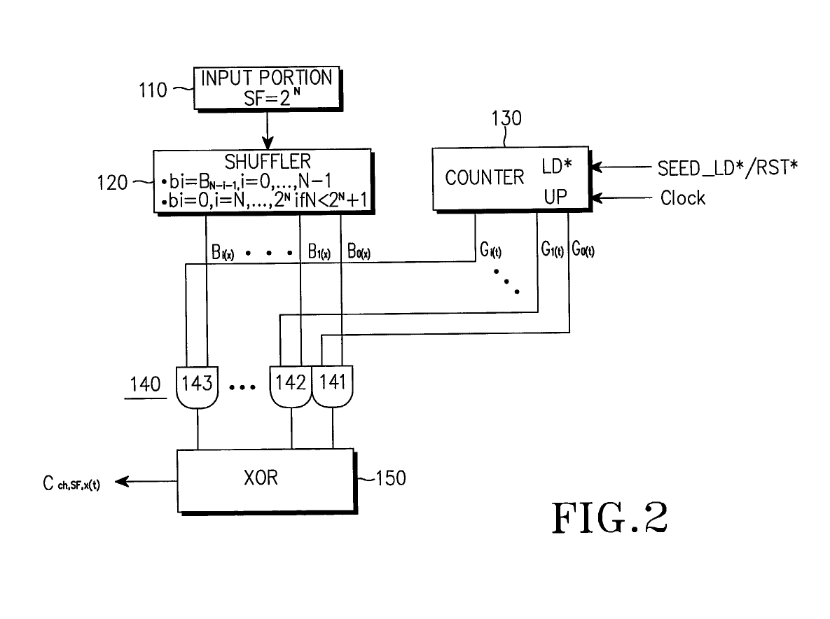

Referring to FIG. 2, an orthogonal code generating apparatus according o an embodiment of the present invention is comprised of an input portion 110, a shuffler 120, a counter 130, an AND gate portion 140, and an XOR gate 150. The input portion 110 outputs a predetermined SF and a channelization code x in an N-bit stream bᵢ(x) (i=0, . . . , N−1). N is determined by Eq. (1). The shuffler 120 shuffles the bit stream bᵢ. The shuffler 120 can be a bit inverter for inverting the N-bit stream on a bit basis. The counter 130 outputs an N-bit count value according to the SF. The counter 130 receives a load signal SPEED_LD* or a reset signal RST* through a terminal LD and a predetermined clock signal (e.g., a PN code clock signal) through a terminal UP. The counter 130 counts according to the PN clock signal. The AND gate portion 140 being a first operation device AND-operates the shuffled bit stream received from the shuffler 120 with the count value received from the counter 130 bit by bit. The XOR gate 150 being a second operation device XOR-operates the operation results received from the first operation device 140 and outputs them as an OVSF code.

For example, if SF=8 and a channelization code 1 is given, the input portion 110 outputs a bit stream “001” for the channelization code 1. The shuffler 120 shuffles the input bit stream by bit inversion and outputs “100”. The counter 130 can be a binary up counter for outputting 0 to 8 (000 to 111) sequentially.

The orthogonal code generating apparatus is so configured that it receives a predetermined SF and a channelization code value, shuffles the channelization code, AND-operates bitwise the shuffled bits with a count value corresponding to the channelization code, XOR-operates the resulting bits, and thus produces a channelization code value at a corresponding timing.

The operation of the orthogonal code generating apparatus illustrated in FIG. 2 will be described below.

N=log₂(SF) (1)

B_{N-i-1}(x)=bᵢ(x) i=0,1, . . . , N−1 (2)

Eq. (1) represents an SF and Eq. (2) represents shuffling the input bits of a channelization code. For example, if SF=8 and a channelization code is “1”, the shuffler (bit inverter) 120 receives an input bit stream bᵢ(x) listed in Table 1 and outputs a bit stream B_{N-i-1}(x) listed in Table 2.

TABLE 1

| Digit | b₂(1) | b₁(1) | b₀(1) |
|---|---|---|---|
| Value | 0 | 0 | 1 |

TABLE 2

| Digit | B₂(3) | B₁(3) | B₀(1) |
|---|---|---|---|
| Value | 1 | 0 | 0 |

The shuffled channelization code is AND-operated with an up-count value and then XOR-operated by Eq. (3). The output of the shuffler 120 is illustrated in Table 4. Table 3 lists up-count values output from the counter 130 when SF=3 and Table 4 lists the outputs of the XOR gate 150 when SF=8 and the channelization code is “1”.

TABLE 3

| t | G₂(t) | G₁(t) | G₀(t) |
|---|---|---|---|
| 0 | 0 | 0 | 0 |
| 1 | 0 | 0 | 1 |
| 2 | 0 | 1 | 0 |
| 3 | 0 | 1 | 1 |
| 4 | 1 | 0 | 0 |
| 5 | 1 | 0 | 1 |
| 6 | 1 | 1 | 0 |
| 7 | 1 | 1 | 1 |

TABLE 4

| t | B₂(3) and G₂(t) | B₁(3) and G₁(t) | B₀(1) and G₀(t) |
|---|---|---|---|
| 0 | 0 | 0 | 0 |
| 1 | 0 | 0 | 0 |
| 2 | 0 | 0 | 0 |
| 3 | 0 | 0 | 0 |
| 4 | 1 | 0 | 0 |
| 5 | 1 | 0 | 0 |
| 6 | 1 | 0 | 0 |
| 7 | 1 | 0 | 0 |

TABLE 5

| | OVSF Code | Mapping Code |
|---|---|---|
| C_{ch,8,1}(0) | 0 | 1 |
| C_{ch,8,1}(1) | 0 | 1 |
| C_{ch,8,1}(2) | 0 | 1 |
| C_{ch,8,1}(3) | 0 | 1 |
| C_{ch,8,1}(4) | 1 | −1 |
| C_{ch,8,1}(5) | 1 | −1 |
| C_{ch,8,1}(6) | 1 | −1 |
| C_{ch,8,1}(7) | 1 | −1 |

Table 5 lists an OVSF code when SF=8 and the channelization code is “1”.

Table 6 below lists OVSF codes generated at each timing.

TABLE 6
$[ \begin{matrix}{C}_{ch , SF , 0} \\ M \\ {C}_{ch , SF , x} \\ M \\ {C}_{ch , SF , SF - 1}\end{matrix} ] = [ \begin{matrix}{C}_{ch , SF , 0} ( 0 ) & {C}_{ch , SF , 0} ( 1 ) & Λ & {C}_{ch , SF , 0} ( SF - 1 ) \\ M & M & & M \\ {C}_{ch , SF , x} ( 0 ) & {C}_{ch , SF , x} ( 1 ) & Λ & {C}_{ch , SF , x} ( SF - 1 ) \\ M & M & & M \\ {C}_{ch , SF , SF - 1} ( 0 ) & {C}_{ch , SF , SF - 1} ( 0 ) & Λ & {C}_{ch , SF , SF - 1} ( SF - 1 )\end{matrix} ]$

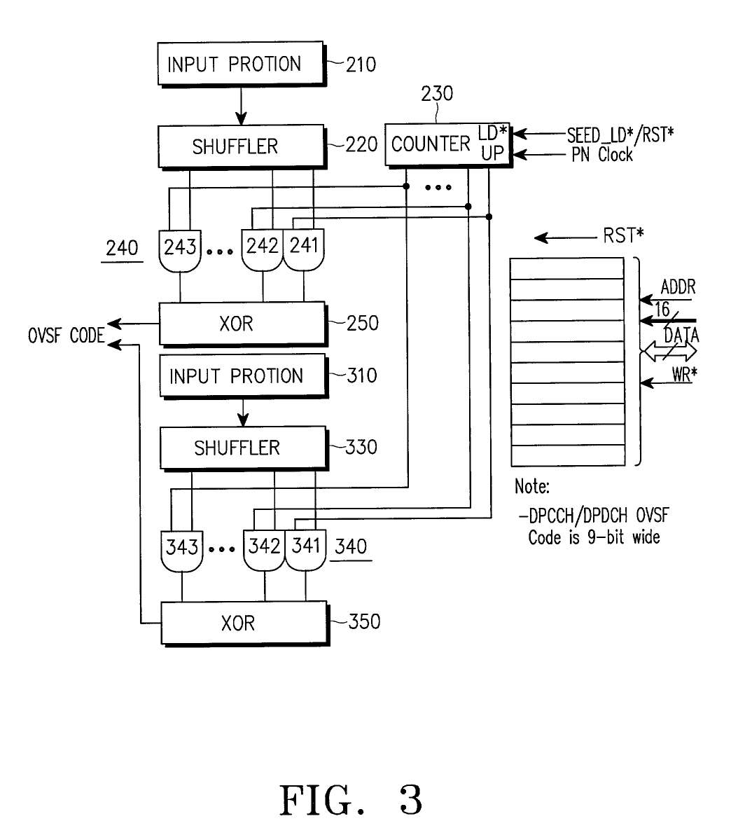

FIG. 3 illustrates an implementation of the orthogonal code generating apparatus according to the embodiment of the present invention. Referring to FIG. 3, the orthogonal code generating apparatus is designed to generate OVSF codes for a DPCCH (Dedicated Physical Control Channel) and a DPDCH (Dedicated Physical Data Channel) as specified by the 3GPP. The orthogonal code generating apparatus can be used for up to an SF of 2⁹. When SF=2^{N}, an up counter, an AND gate portion, and an XOR gate are configured to operate N bits. A DPCCH orthogonal code generator is comprised of an input portion 210, a shuffler (bit inverter) 220, a counter 230, an AND gate portion 240, and an XOR gate 250. A DPDCH orthogonal code generator is comprised of an input portion 310, a shuffler (bit inverter) 330, the counter 230, an AND gate portion 340, and an XOR gate 350.

Input parameters for generation of OVSF codes are an SF and a channelization code. The OVSF codes are used as channelization codes for data spreading or despreading in 3GPP Layer 1. The orthogonal code generator is used to identify a channel in spreaders of a Node B and a UE, and generates an orthogonal code with the same chip rate as an output code of a scrambling code generator.

The counter 230 is periodically reset to 0 by the load signal SEED_LD*. Binary bits output from the counter 230 are AND-operated with shuffled channelization code bits in the AND gate portion 240 bit by bit. The resulting bits are XOR-operated in the XOR gates 250 and 350, thereby producing OVSF codes at a chip level (e.g., 3.84 MHz in 3GPP).

While the orthogonal code generators have been illustrated separately for the DPCCH and the DPDCH, one of both the same orthogonal code generators can be used in a transmitter of a Node B. An orthogonal code generating apparatus in a UE is configured in a reverse order to the orthogonal code generating apparatus of the Node B.

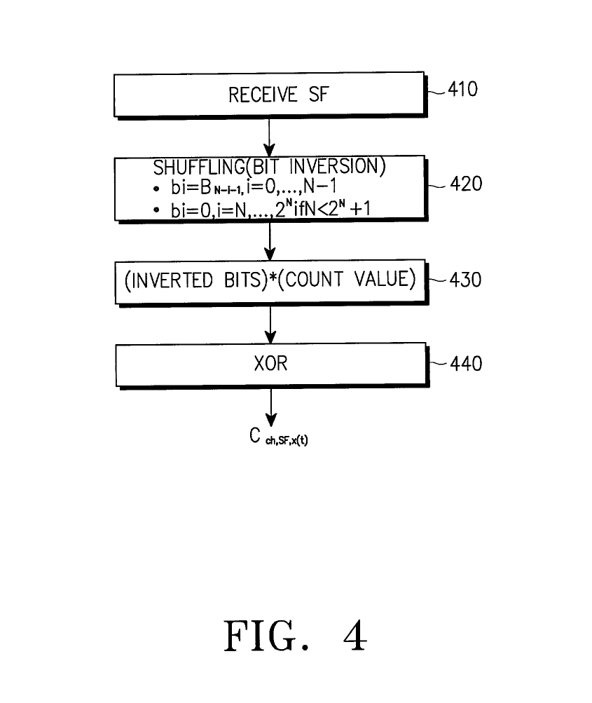

FIG. 4 is a flowchart illustrating orthogonal code generation according to the embodiment of the present invention. Referring to FIG. 4, the orthogonal code generating apparatus receives an SF and a channelization code in step 410, shuffles the bits of the channelization code in step 420, AND-operates bitwise the shuffled bits with a count value corresponding to the channelization code in step 430, and XOR-operates the AND-operated bits in step 440. Thus, a channelization code value is generated at a corresponding timing. The shuffling in step 420 is bit inversion.

Table 7, Table 8 and Table 9 illustrate the operation of the orthogonal code generating apparatus at each timing level.

TABLE 7

| Decimal | Binary count | | | | | | | | |
|---|---|---|---|---|---|---|---|---|---|
| count | g (8) | g (7) | g (6) | g (5) | g (4) | g (3) | g (2) | g (1) | g (0) |
| 0 | 0 | 0 | 0 | 0 | 0 | 0 | 0 | 0 | 0 |
| 1 | 0 | 0 | 0 | 0 | 0 | 0 | 0 | 0 | 1 |
| 2 | 0 | 0 | 0 | 0 | 0 | 0 | 0 | 1 | 0 |
| 3 | 0 | 0 | 0 | 0 | 0 | 0 | 0 | 1 | 1 |
| 4 | 0 | 0 | 0 | 0 | 0 | 0 | 1 | 0 | 0 |
| 5 | 0 | 0 | 0 | 0 | 0 | 0 | 1 | 0 | 1 |
| : | : | : | : | : | : | : | : | : | : |
| : | : | : | : | : | : | : | : | : | : |
| 508 | 1 | 1 | 1 | 1 | 1 | 1 | 1 | 0 | 0 |
| 509 | 1 | 1 | 1 | 1 | 1 | 1 | 1 | 0 | 1 |
| 510 | 1 | 1 | 1 | 1 | 1 | 1 | 1 | 1 | 0 |
| 511 | 1 | 1 | 1 | 1 | 1 | 1 | 1 | 1 | 1 |

TABLE 8

| | Shuffled channelization code | | | | | | | | |
|---|---|---|---|---|---|---|---|---|---|
| Count | b (8) | b (7) | b (6) | b (5) | b (4) | b (3) | b (2) | b (1) | b (0) |
| 0 | b (0) | b (1) | b (2) | b (3) | b (4) | b (5) | b (6) | b (7) | b (8) |
| 1 | | | | | | | | | |
| 2 | | | | | | | | | |
| 3 | | | | | | | | | |
| 4 | | | | | | | | | |
| 5 | | | | | | | | | |
| : | | | | | | | | | |
| : | | | | | | | | | |
| 508 | | | | | | | | | |
| 509 | | | | | | | | | |
| 510 | | | | | | | | | |
| 511 | | | | | | | | | |

TABLE 9

| Decimal | |
|---|---|
| count | 9-bit XOR-operated bits |
| value | (XOR operation expressed as ˆ ) |
| 0 | 0 |
| 1 | b(8) |
| 2 | b(7) |
| 3 | b(7) ˆ b(8) |
| 4 | b(6) ˆ |
| 5 | b(6) ˆ b(8) |
| . | |
| . | |
| . | |
| . | |
| . | |
| . | |
| 508 | b(0) ˆ b(1) ˆ b(2) ˆ b(3) ˆ b(4) ˆ b(5) ˆ b(6) |
| 509 | b(0) ˆ b(1) ˆ b(2) ˆ b(3) ˆ b(4) ˆ b(5) ˆ b(6) ˆ b(8) |
| 510 | b(0) ˆ b(1) ˆ b(2) ˆ b(3) ˆ b(4) ˆ b(5) ˆ b(6) ˆ b(7) |
| 511 | b(0) ˆ b(1) ˆ b(2) ˆ b(3) ˆ b(4) ˆ b(5) ˆ b(6) ˆ b(7) ˆ b(8) |

Table 7, Table 8 and Table 9 list count values output from the up counter 130 at each timing ranging from 0 to 511, inverted bits of a channelization code, and an OVSF code resulting from XOR-operation of the count values and the inverted bits, respectively. While a 9-bit OVSF code is generated in the above example, OVSF codes with N windows can be generated. The simple OVSF code generating mechanism of bit inversion, up counting, AND operation, and XOR operation at each timing obviates the need for a hold time involved with memory access. Therefore, OVSF codes can be generated rapidly and chip development is facilitated.

In accordance with the present invention, there is no need for a memory when generating OVSF codes in a CDMA communication system, thereby enabling rapid OVSF code generation. Furthermore, an orthogonal code generating apparatus can be efficiently designed in an ASIC design.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. An OVSF (Orthogonal Variable Spreading Factor) code generating apparatus in a CDMA (Code Division Multiple Access) communication system, comprising:
a shuffler for shuffling an N-bit stream, N being determined by the SF (Spreading code) of an OVSF code and N=log₂SF;
a counter for outputting an N-bit count value;
a first operation device for AND-operating the shuffled bits with the N-bit count value bit by bit; and
a second operation device for XOR-operating the AND-operated bits and outputting the XOR-operated bits as an OVSF code.

2. The OVSF code generating apparatus of claim 1, wherein the shuffler is an inverter for inverting the N-bit stream on a bit basis.

3. The OVSF code generating apparatus of claim 1, wherein the counter is a binary up counter for outputting an N-bit count value that increases according to a PN (Pseudorandom Noise) code clock signal.

4. The OVSF code generating apparatus of claim 1, wherein the OVSF code is used for a DPCCH (Dedicated Physical Control Channel).

5. The OVSF code generating apparatus of claim 1, wherein the OVSF code is used for a DPDCH (Dedicated Physical Data Channel).

6. An OVSF (Orthogonal Variable Spreading Factor) code generating method in a CDMA (Code Division Multiple Access) communication system, comprising the steps of:
shuffling an N-bit stream, N being determined by the SF (Spreading code) of an OVSF code and N=log₂SF;
outputting an N-bit count value;
AND-operating the shuffled bits with the N-bit count value bit by bit; and
XOR-operating the AND-operated bits and outputting the XOR-operated bits as an OVSF code.

7. The OVSF code generating method of claim 6, wherein the shuffled bit stream is bits inverted on a bit basis.

8. The OVSF code generating method of claim 6, wherein the N-bit count value increases according to a PN (Pseudorandom Noise) code clock signal.

9. The OVSF code generating method of claim 6, wherein the OVSF code is used for a DPCCH (Dedicated Physical Control Channel).

10. The OVSF code generating method of claim 6, wherein the OVSF code is used for a DPDCH (Dedicated Physical Data Channel).
